(19) United States
(12) Patent Application Publication
(10) Pub. No.: US 2014/0060336 A1
(43) Pub. Date: Mar. 6, 2014

(54) Apparatus for Making Crema Coffee

(71) Applicants: Carl Campetella, Staten Island, NY (US); Gil Garcia, Staten Island, NY (US)

(72) Inventors: Carl Campetella, Staten Island, NY (US); Gil Garcia, Staten Island, NY (US)

(21) Appl. No.: 14/072,714

(22) Filed: Nov. 5, 2013

Related U.S. Application Data
(63) Continuation-in-part of application No. 11/499,837, filed on Aug. 4, 2006, now Pat. No. 8,601,937.
Application No. 11/499,837 is a continuation-in-part of application No. 11/362,597, filed on Feb. 23, 2006, now Pat. No. 7,927,642.

(51) Int. Cl. A47J 31/42

(52) U.S. Cl. CPC A47J 31/42
USPC 99/286; 99/297

(57) ABSTRACT

This invention relates generally to an apparatus for making crema coffee. More particularly, the invention is directed to an apparatus specifically directed to brew crema coffee.

This application is a continuation-in-part application of U.S. patent application Ser. No. 11/499,837 filed Aug. 4, 2006, which was a continuation in part of U.S. patent application Ser. No. 11/362,597 filed Feb. 23, 2006, now U.S. Pat. No. 7,927,642 and claims all benefits pertaining thereto under 35 U.S.C. 120.

### FIELD OF THE INVENTION

This invention relates generally to an apparatus for making Crema coffee. More particularly, the invention is directed to an apparatus specifically directed to brew Crema coffee.

### BACKGROUND OF THE INVENTION

Coffee has been consumed as a beverage for centuries. Over time, a wide variety of coffee-making methods and devices have been developed, e.g. percolators, vacuum pots, the “French press,” drip coffee makers, and others. During the first half of the 20th century, the espresso machine was developed in Italy. The principle of the espresso machine was to bring hot (but not boiling) water, under pressure, in contact with a quantity of finely ground, compressed coffee beans for a relatively short period of time, thereby producing one or two very small cups of highly flavored coffee.

The flavorful nature of espresso is mainly due to the layer of golden-colored Crema floating at the top of the cup. The Crema comprises emulsified oils and other substances extracted from the ground coffee beans by the pressurized water. Besides playing a key role in transmitting flavor, the Crema layer has a visual appeal similar to that of a head on a glass of beer.

Other aspects of the espresso-making process that enhance the flavor are: 1) The hot water is in contact with the ground coffee for a relatively short time, long enough to extract flavor components but not so long as to damage them; and 2) Espresso is made as a single serving (or sometimes two servings), intended for immediate consumption, which prevents flavor components from degrading or evaporating. The particle size of the coffee ground used to produce espresso is also specific. As is known, the particle size is about 0.010 inches, or 0.3 millimeters (U.S. Pat. Nos. 5,244,159 and 6,016,740).

These aspects of espresso-making are to be contrasted with other methods that involve the brewing of multi-cup quantities of coffee, which is then kept hot until consumed. Such methods typically require a longer period of contact between the ground coffee and the hot water, which can damage flavor components, and then some period of time between brewing and consumption, which can allow flavor components to degrade or escape through evaporation.

While existing methods of brewing coffee using espresso machines produce very flavorful coffee with an attractive Crema layer, the coffee produced by such machines and processes is very thick and concentrated. Espresso as it emerges from the machine has been described as having the consistency of warm honey. The flavor is also very robust or strong. The quantity of coffee per cup is very small, on the order of one ounce. Because the quantity is small and the flavor volatile, it is usually consumed quickly, often while standing at a bar. This style of coffee is very much in favor in continental Europe, e.g. in France, Italy, and Spain, but is very different from the style of coffee chiefly favored in the United States.

While espresso consumption has increased markedly in the United States in recent decades, most coffee consumed in the United States is of a very different style, being less concentrated, less thick (less viscous), and less strongly flavored. Individual servings are also much larger, ranging from perhaps 6 to 20 ounces. Because this coffee is less concentrated and served in much larger quantity, different social rituals are associated with its consumption, compared to the quick consumption of espresso at a European espresso bar. In America, the large cups of low-concentration coffee are sipped over a relatively long period of time, for example as an accompaniment to a meal, or at a desk while working, or in a car while commuting.

In Europe, this style of coffee is called American Coffee and it is sometimes

simulated by mixing together espresso and hot water. This, however, defeats the flavor preserving advantages of the normal espresso method and destroys the Crema layer. At the same time, American tastes have become much more sophisticated, and many Americans, while continuing to prefer a large cup of coffee that can be sipped over time, would enjoy the visual appeal and flavor enhancement of a Crema layer on the coffee. What is needed is a method for producing large servings of relatively low concentration coffee (i.e. American coffee) with some of the desirable characteristics of espresso, such as enhanced flavor and Crema.

What is needed is an apparatus for producing large servings of relatively low-concentration coffee (i.e. American coffee) with some of the desirable characteristics of espresso, such as enhanced flavor and Crema, as well as new properties such as lowered acidity and higher caffeine content.

### SUMMARY OF THE INVENTION

The present invention is an apparatus for brewing a novel type of coffee known as Crema Coffee (the method of making described in U.S. Pat. No. 7,927,642). The uniqueness of the method required for making this type of coffee is such that a novel apparatus was created through the present invention. No other apparatus currently exists or has been conceived that produces the Crema Coffee.

An apparatus for making Crema coffee-is disclosed. The apparatus of the present invention is capable of producing a serving of Crema Coffee in about 20 seconds, depending on the ending serving size. In one aspect, the apparatus executes a method for brewing Crema Coffee comprises the steps of transferring ground coffee to a brewing chamber, compressing the ground coffee, and forcing pressurized hot water through the ground coffee, thereby causing brewed coffee to emerge through a micro-filter, wherein the ratio of weight of ground coffee contained in the brewing chamber to volume of pressurized hot water forced through the ground coffee is 6 grams per fluid ounce or less. The Crema Coffee beverage produced by this apparatus is also disclosed, preferably resulting in a single serving of about 12 to 20 fluid ounces. Preferably, the Crema Coffee has a layer of Crema, which may be about ¼″ deep and may last for at least 10 minutes and up to 30 minutes. In one aspect of the disclosure, the ground coffee is ground more coarsely than espresso coffee.

The coffee may be ground, within the apparatus, with burrs set between ¼″ and ⅜″ apart. The coffee may be ground using a slicing method. The grinders slice the whole coffee beans at exactly the correct angle such that the coffee grind is exactly the same from brew to brew. The amount of ground coffee transferred to the brewing chamber may be between about 13 grams and about 22 grams. The amount of pressurized hot water forced through the ground coffee may be between about 10 fluid ounces and 26 fluid ounces. In one specific embodiment, the brewing chamber can hold at least 22 grams of ground coffee at one time. The coffee may be compressed with more than 30 pounds of force distributed across the upper surface of the ground coffee. The coffee may be compressed with about 40 pounds of force distributed across the upper surface of the coffee.

In a specific embodiment, the coffee is compressed by a piston mechanism. In one aspect, the temperature of the water is more than 198 degrees Fahrenheit. The temperature of the water may be about 204 degrees Fahrenheit. The pressure of the water may be between 90 and 125 pounds per square inch. In one aspect, the step of forcing water through the coffee has a duration of approximately 12 seconds. In a specific embodiment, the microfilter is made of a material having a low heat conductivity, such as TEFLON. The material of which the microfilter is made may be PVC plastic, or steel.

The present invention is a programmable apparatus employing a multitude of adjustments to existing coffee makers to result in the unique Crema Coffee. Without specific and novel changes made to existing coffee makers to produce the present invention (the larger chamber, the enlarged piston, the temperature of the water, the pounds per square inch or PSI of water, the steel microfilter), the apparatus would not have the capability to produce the unique formula required for Crema Coffee. The multitude of adjustments made to any existing apparatus are vast. Members of the coffee making community have consistently stated that the ability to create the present invention capable of consistently producing Crema Coffee would be unlikely, if not impossible.

The apparatus of the present invention produces Crema Coffee that is crowned with golden color froth . . . preserving a full aroma for the customer to enjoy. The froth seals both the flavor of the coffee as well as extending the shelf life of the product. The apparatus of the present invention creates a product that is created with a short brew time relative to American Coffee and is consistent from cup to cup. Moreover, the Crema Coffee produced by the apparatus has a lower acidity than that of drip coffee (American Coffee), and is there for more palatable and attuned with the stomach of the consumer. Additionally, the present apparatus produces a coffee product with a substantially higher caffeine content than its available single serve counterparts, another advantage to many consumers.

In addition to the recognized substantial improvement of the product and apparatus capable of producing Crema Coffee, there is substantial evidence indicating that the result of the present invention due to the extensive modification of available single cup brewers was entirely unexpected. For instance café entrepreneurs have stated that they were “doubtful that an apparatus could be created to produce this new, Crema Coffee.” Coffee afficianados have expressed amazement that an apparatus capable produced the Crema Coffee product could be constructed. Moreover, such persons have stated that they would not know how to create such an apparatus. In fact, many persons in the art encountered by the co-inventors have expressed the same surprise and disbelief that such an apparatus was made by the inventors and that the apparatus is able to produce Crema Coffee. Indeed, as stated above the method for producing Crema Coffee is the subject of U.S. Pat. No. 7,927,642, and was invented by the co-inventors of the present invention.

In fact, many persons in the art encountered by the co-inventors have expressed the same surprise and disbelief that such an apparatus was made by the inventors and that the apparatus is able to produce Crema Coffee.

In one embodiment, a programmable apparatus for making coffee comprises a hopper for holding coffee beans, a grinding element for receiving the coffee beans and grinding them to produce ground coffee, a brewing chamber for receiving programmable quantities of ground coffee and combining the ground coffee with quantities of hot, pressurized water, a piston for compressing the ground coffee, the piston being arranged to enter the brewing chamber at an open end thereof, and an o-ring fitted to the outside of the piston so as to maintain a pressure-tight seal against the wall of the brewing chamber, and a programming element for selectively determining a quantity C of ground coffee to be combined with a quantity W of water in the brewing chamber, the brewing chamber being capable of accommodating more than 14 grams of ground coffee. In one embodiment, C is 14 grams or less and W is at least 8 fluid ounces. In another embodiment, C is more than 14 grams, and W is at least 16 fluid ounces.

The pressure of the pressurized water may be 125 pounds per square inch or less. The pressure of the pressurized water may be about 90 pounds per square inch. The dimensions of the brewing chamber may be selected so that it can accommodate up to about 24 grams of ground coffee. The brewing chamber may be cylindrical and may have an inside diameter of at least 2 inches. The grinding element may comprise burrs set between ¼″ and ⅜″ apart. The grinding element may grind the coffee more coarsely than ground espresso coffee. In one embodiment, the values of C and W are selected such that C divided by W is 6 grams per fluid ounce or less. The piston may further comprise, at its bottom surface, a quantity of infusion holes, the diameter of the holes being about 2 mm. The piston may further comprise a layer of Teflon tape interposed between the o-ring and the outside surface of the piston.

In another embodiment, an apparatus for brewing coffee comprises a brewing chamber having a microfilter, means for compressing ground coffee in the brewing chamber, and means for forcing hot water through the ground coffee in the brewing chamber, thereby causing brewed coffee to emerge through the microfilter; wherein the ratio of weight of ground coffee contained in the brewing chamber to volume of pressurized hot water forced through the ground coffee is 6 grams per fluid ounce or less.

The apparatus may further comprise means for storing coffee beans, and means for grinding coffee beans to produce ground coffee. The grinding means may comprise burrs set between ¼″ and ⅜″ apart. The grinding means may employ a slicing method of grinding. The grinding means may produce ground coffee more coarsely ground than ground espresso. The brewing chamber may be able to hold at least 14 grams of ground coffee. The amount of pressurized hot water forced through the ground coffee may be greater than 8 fluid ounces. The brewing chamber may be able to hold at least 18 grams of ground coffee at one time. The means for compressing may provide more than 30 pounds of force distributed across the upper surface of the coffee. The apparatus may further comprise means for heating the water to more than 198 degrees Fahrenheit. The apparatus may further comprise means for heating the water to about 204 degrees Fahrenheit. The apparatus may further comprise means for creating and sustaining a water pressure of between 90 and 125 pounds per square inch, or of 110 pounds per square inch or less, or of about 95 pounds per square inch.

### BRIEF DESCRIPTION OFT HE DRAWINGS

A more complete understanding of the present invention and certain advantages thereof may be acquired by referring to the following description in consideration with the accompanying drawings, in which like reference numbers indicate like features and wherein:

FIG. 1 depicts exemplary apparatus for making coffee, according to one embodiment of the invention.

FIG. 2 is a flow chart of an exemplary process for making coffee, according to an embodiment of the invention.

FIG. 3 illustrates the brewing chamber and piston, according to an embodiment of the present invention.

### DETAILED DESCRIPTION OF THE INVENTION

The invention described in detail herein generally relates to an apparatus and method for making coffee. In the following description of various examples of the invention, reference is made to the accompanying drawings, which form a part hereof, and which are shown by way of illustration. It is to be understood that other specific arrangements of parts, sample systems may be utilized and structural and functional modifications may be made without departing from the scope of the invention.

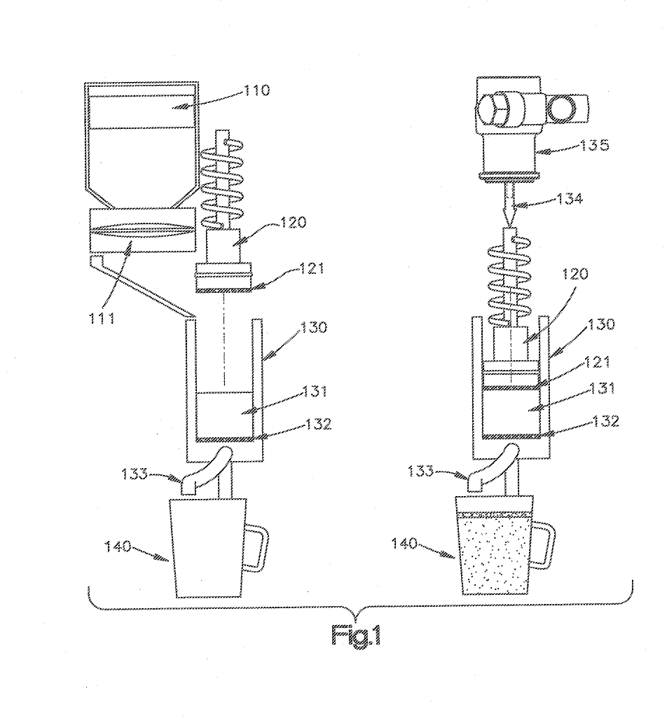

FIG. 1 depicts an example apparatus that can be used in making coffee. The apparatus is intended as an example only, and other devices capable of performing the method steps discussed below can be used instead.

Hopper 110 holds whole coffee beans. In the preferred embodiment, the hopper 110, is capable of holding approximately 2.5 lbs. of coffee beans. Notably, less coffee beans per ounce of produced coffee are used than in traditional coffee or espresso makers. Specifically, 15 grams of beans produce 12 ounces of Crema Coffee in the present invention (or 1.25 grams or beans per ounce of brewed Crema Coffee), whereas a traditional brewer would use 57 grams of beans to produce 32 ounces, or a full pot of American coffee, and whereas 45 grams of beans would be used for 12 ounces of French Press Coffee.

Grinding element 111 receives whole beans from hopper 110 and grinds or mills them to produce ground coffee 131 (also sometimes referred to as coffee grinds or coffee grounds). In one embodiment, grinding element 111 is of the European burr type, with adjustable burrs, although other types of coffee grinders or mills can be used. In a preferred embodiment, the burrs of grinding element 111 are arranged to grind the coffee with a slicing action. This slicing action is imperative to the resulting Crema Coffee product. Adjustable burrs should preferably be set between ¼″ and ⅜″ apart in order to cut the whole bean to a desirable size, allowing for a courser grind for the desired taste, consistency and texture. Espresso uses a finer cut (almost powder-like) and produces a stronger taste.

Ground coffee 131 produced by the slicing action of grinding element 111 differs from ground espresso coffee in consistency and fineness. In particular, it is substantially less fine than ground espresso coffee. In the preferred embodiment, the grind is approximately 4.5 complete rotations from the widest opening (as consistent with industry standard). The resultant grounds are of a consistent size, approximately 16 to 18.5 mm in diameter. The size of the grind depends largely on the Coffee bean used. Beans with stronger flavor may be ground more coarsely to attain appropriate flavor. Type of roast also determines size of grind, wherein a deeper roast may be ground more coarsely to attain good flavor. Conversely, lighter roasts and more delicate Coffee beans will use a finer roast. Adjusting grind size dependent on type of bean and roast is well known. In the preferred embodiment, a grind size of approximately 17 mm is used for a Columbian bean.

Ground coffee 131 is then transferred to brewing chamber 130. Brewing chamber 130 must be large enough to accommodate quantities of ground coffee 131 and hot water sufficient to produce a large cup of coffee. Preferably, brewing chamber 130 is sized to accommodate 13 to 22 grams of ground coffee 131. The amount of ground coffee to be used is intricately connected to the quantity of Crema Coffee desired. Specifically, either 12, 16, or 20 ounces per serving produced and where 15 grams of beans will produce 12 ounces of Crema Coffee (or 1.25 grams of beans per ounce of brewed product). The brewing chamber terminates in the first microfilter 132 discussed further, below.

Piston 120 compresses ground coffee 131, preferably with more than 30 pounds of force distributed across the upper surface of the coffee, and most preferably with about 40 pounds of force. Piston 120 can be driven by a spring, as shown, or by some other mechanism capable of imparting the required force. In another variation, ground coffee 131 can be compressed manually.

Compressing ground coffee 131 is necessary in order to sustain uniform high-pressure contact between the grounds of ground coffee 131 and hot water. The force, of about 40 pounds, is higher than the force used in compressing espresso coffee, which is normally about 30 pounds. The higher force is necessitated by the consistency and fineness of ground coffee 131 which, as noted above, differs from the consistency and fineness of ground espresso coffee. If the force may be applied manually, preferably the force is between about 35 and 45 pounds.

Pressurized hot water 134 is forced through piston 120, then through second microfilter 121, and then through ground coffee 131. The surface area of ground coffee exposed to the hot water 134 is 2 and ⅛^{th} inches. This surface area, in conjunction with grind size, pressure, temperature and other variables produces the coffee with a Crema layer. In one embodiment, the bottom of piston 120 has infusion holes that admit water through microfilter 121 into the brewing chamber.

The second microfilter 121 acts as a shower screen to spread water evenly over the grounds and also prevents grounds from escaping out the top of the brewing chamber. In one embodiment, the infusion holes are enlarged to allow more water through the grinds in order to make a larger cup of coffee. Preferably, the size of the infusion holes is about 2 mm. The size of 2 mm allows for the exact amount of force needed to cover the ground coffee in a shower-like spay with sufficient pressure in order to extract an create the Crema Coffee. In a preferred embodiment, there are 5 infusion holes. The second microfilter 121 can be made of a metal (e.g. stainless steel), or of a low heat-conductivity material, such as Teflon or PVC plastic.

The temperature of the water should be below the boiling point (i.e., below 212 degrees Fahrenheit). On the other hand, the temperature of the water should be high enough so that the product produced by the apparatus is a hot cup of coffee that will remain pleasantly hot when consumed over a relatively long period of time, as opposed to the quick consumption of a cup of espresso. Therefore, while the temperature of the water used in espresso-making is typically in the range of from 190 to 203 degrees Fahrenheit (see, e.g., coffeeresearch.orglespresso/definitions.htm, visited February, 2006), the temperature of pressurized hot water 134 is at the high end of this range or higher. Preferably, the temperature of pressurized hot water 134 is about 204 degrees Fahrenheit. However, other temperatures may be used and will vary as to the type of bean and roast used.

If the water used in the present invention is below 194 degrees, it will adversely affect the taste and Crema Coffee will not result. If the temperature of the water is above 210 degrees, the resultant product will taste burned, and would not be Crema Coffee. Moreover, in the preferred embodiment the apparatus uses a tankless operating system. This type of heat on demand system provides a constant and consistent source of hot water. The water in this system runs through a coil, which heats the water to the specified preset temperature. As is known, the heating element operates only as the water flows through the coil and does not operate without water, thus avoiding the coil being operational at all times. Consistency of temperature is integral to the successful operation of the apparatus in producing Crema Coffee. In contrast, a boiler does not provide sufficient consistency for the proper operation of the apparatus of the present invention because it fails to provide a continuous flow of hot water in a timely fashion.

Preferably, the pressure of pressurized hot water 134 is between about 90 to 125 pounds per square inch. This provides the process with the exact amount of pressure for the correct extraction. In one embodiment, the pressure is approximately 90 to 110 pounds per square inch. However, other pressures may be used. The water pressure may be created and sustained by an electric pump or other suitable mechanism. In the case of the Columbian bean, a pressure of 110 pounds per square inch is used.

The pressurized water passes through the grounds for differing times dependent on grind size and pressure. In general, grounds are exposed to the pressurized water for approximately 12 seconds for a 12 ounce serving, 14 seconds for a 16 ounce serving, and 16 seconds for a 20 ounce serving of Crema Coffee. For other serving sizes, the time per serving is approximately 1 second per ounce to 12 ounces, and an additional 2 seconds per four ounces for serving sizes greater than 12 ounces. These parameters are applicable at a high pressure (approximately 115 pounds per square inch). For instance, grounds may be exposed to the hot pressurized water for 2.4 seconds per ounce for a 12 ounce serving, 2.03 seconds per ounce for a 16 ounce serving, and 1.8 seconds per ounce for a 20 ounce serving. Altering the pressure of the water will affect time of the water passing through the grinds. Type of coffee beans and roast also will affect brew time.

No traditional coffee filter is used between the beans and the brewing chamber as the grind size is sufficient to not move through the brewer. Hence, there is less waste in brewing with the apparatus of the present invention.

Brewed coffee then emerges from first microfilter 132 and passes through coffee spout 133 and into cup 140. The first microfilter 132 can be made of metal (e.g. stainless steel), or of a low heat-conductivity material, such as Teflon or PVC plastic. The first microfilter 132 prevents any additional grounds from being present in the final Crema Coffee serving. In one embodiment cup 140 has a capacity or serving size of 12 to 20 ounces. However, other capacities or serving sizes, such as 5 ounces, 6 ounces, or 24 ounces, or other sizes, may be provided. The coffee in cup 140 produced in the above way typically has a Crema layer 141. Preferably, crema layer 141 is about ¼″ deep, but a different depth can be achieved with different coffee blends. Preferably, the Crema layer lasts for at least 10 minutes, which time may vary in different cases. The depth and duration of the crema is determined by multiple factors, including the water pressure, water temperature and type of filter employed, as described herein.

The pH is higher than that of traditional American coffee or espresso, resulting in a lower acidity. Increased pH of the crema coffee brewed by the present apparatus is due to the pressure brewing described above. This lower acidity is advantageous to many consumers.

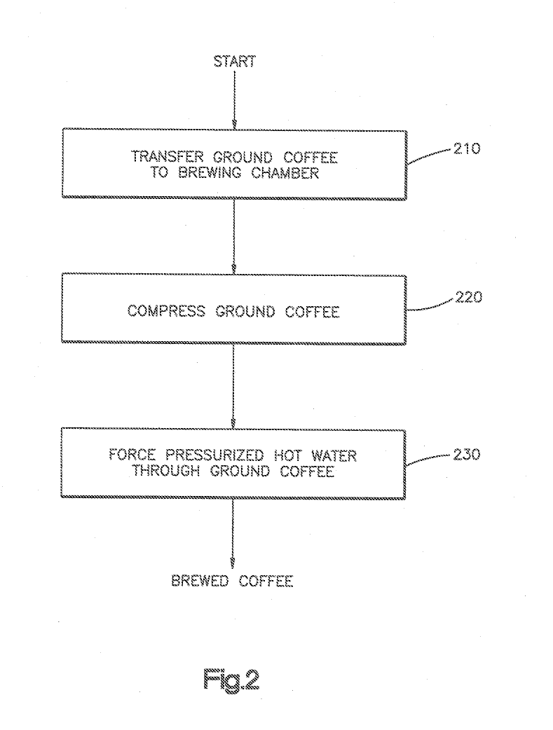

FIG. 2 is a flowchart describing the steps of an exemplary method for making coffee.

Not illustrated, the first step is to grind the coffee, as described above.

At step 210, ground coffee is transferred to a brewing chamber.

At step 220, the ground coffee is compressed.

At step 230, pressurized hot water is forced through the ground coffee, wherein the ratio of weight of ground coffee to volume of pressurized hot water is 6 grams per fluid ounce or less, resulting in the production of brewed coffee.

In some embodiments, the coffee-making apparatus is programmable, meaning that one or more of the brewing parameters discussed above can be adjusted or selected by programming a controlling element, or programming element 200 of the apparatus, e.g. a microprocessor (See FIG. 2). For example, the amount of ground coffee transferred to the brewing chamber and the amount of hot water forced through the ground coffee may be programmable. Other brewing parameters that may be programmable in various embodiments include: infusion time; spacing of the grinder burrs; coarseness or fineness of the grind produced by the grinding element; pounds of force used to compress the ground coffee; temperature of the water; volume of water; and water pressure. In some embodiments, one or more of these parameters may be adjustable by some mechanism other than microprocessor control, e.g. by turning a knob or an adjusting screw. The programming element 200 is depicted in FIG. 2.

The apparatus can be controlled by a processor executing a program to execute the steps described above. The processor can be automatically reset to factory settings so that the user does not need to input the above parameters and the apparatus is capable only of producing Crema Coffee. Moreover, a Printed Circuit Board (PCB) may be utilized in the present invention to expand the Crema Coffee program. The PCB will contain many of the crucial electronic components of the system such as the central processing unit (CPU) and memory, and provides connectors for other peripherals throughout the machine. The motherboard contains significant subsystems such as the processor.

A CPU is the hardware of the computer system that may be contained within the present invention and carries out the instructions of a program and performs the basic arithmetic, logic, and input/output operation of the present invention.

Another parameter that may be programmable or adjustable in various embodiments is the number N of brewing cycles. A brewing cycle comprises transferring a quantity of C grams of ground coffee to the brewing chamber, compressing the ground coffee, passing W fluid ounces of pressurized hot water through the ground coffee so as to produce a quantity of coffee beverage, and expelling the used coffee grounds from the brewing chamber. The total volume of coffee beverage produced is about N times W. A larger quantity of coffee can be brewed by selecting larger values of N. The maximum value of C, the amount of ground coffee per brewing cycle, is limited by the size of the brewing chamber. In conventional programmable espresso machines, the brewing chamber can hold no more than about 14 grams of ground coffee, which is the amount needed for a double espresso.

In one embodiment, the problem of producing relatively large servings of relatively low-concentration coffee with some of the desirable characteristics of espresso is solved by programming a programmable espresso machine to perform a sufficient number of brewing cycles to produce the quantity desired, while programming the amounts of ground coffee and pressurized hot water used per brewing cycle to adjust the concentration to the desired level. For example, if N is set to 2, C is set to 10, and W is set to 8, a serving of about N×2=16 fluid ounces of coffee beverage with a concentration of 10/8=1.25 grams of coffee per fluid ounce of water can be produced. In this embodiment, the conventional espresso brewing chamber holding not more than about 14 grams of ground coffee can be used.

In a variation, the parameter N is not electronically programmable, but an equivalent result is obtained by manually cycling the apparatus N times.

The embodiment just described can be characterized as a “software” solution in that it can be implemented by changing the programming of a programmable espresso machine. However, in some applications, for example commercial applications where the time to produce a single cup of coffee is an important factor, it may be desirable to produce a large cup of coffee in a single cycle. This can be accomplished by enlarging the brewing chamber beyond the dimensions of the conventional espresso brewing chamber

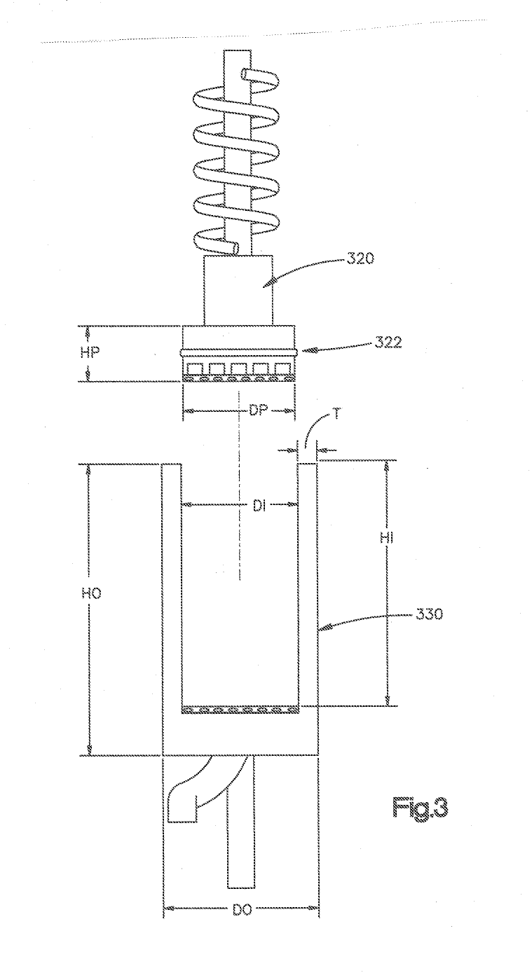

FIG. 3 shows an enlarged brewing chamber 330. In a preferred embodiment, an enlarged brewing chamber can hold up to about 24 grams of ground coffee. In a preferred embodiment, the dimensions of the brewing chamber are: inside diameter DI 2⅛″; inside height HI 1½″; outside diameter DO 2 7/16″.

Also shown in FIG. 3 is an enlarged piston 320 sized to fit within brewing chamber 330 such that o-ring 322 makes a water-tight seal with the inside surface of brewing chamber 330.

One consequence of enlarging piston 320 follows from the well-known relation between force F on a piston, the pressure P of liquid within the piston, and the area A of the piston head, which is F=PA. That is, if the pressure P of pressurized water in the brewing chamber is kept constant, the increased area A of the enlarged piston will cause an increased force F to be exerted on the piston, compared to the equivalent force experienced in the conventional espresso brewing chamber. The inventors have found that this increased upward force on the piston has the effect of tending to break the seal of the o-ring against the chamber wall, thus permitting an undesirable leakage of water from the chamber.

In one embodiment, this effect is mitigated by improving the seal of the o-ring, for example by interposing a layer of Teflon tape between the o-ring and the outside surface of the piston.

In another embodiment, this effect is mitigated by reducing the water pressure. Whereas conventional espresso makers employ pressures in the neighborhood of 140 psi (see, e.g. “espresso” at wikipedia.com), the inventors have found that flavorful coffee can be brewed in this apparatus at pressures of less than 100 psi. In a preferred embodiment, the pressure is 90 psi. At least in part, this is believed to be due to the fact that the larger infusion surface 320 of the enlarged piston compensates for the reduced pressure.

In one embodiment, a programmable coffee-making apparatus is arranged to produce a single serving of at least 16 fluid ounces of coffee in a single brewing cycle (N=1) using an amount of ground coffee C of more than 14 grams and an amount of hot pressurized water W of at least 16 fluid ounces and a brewing chamber with dimensions selected to accommodate more than 14 grams of ground coffee.

Also, the ratio of the weight of ground coffee in the brewing chamber to the volume of pressurized hot water forced through it at step 230 differs significantly from the corresponding parameter in the brewing of traditional espresso. In the brewing of espresso, this ratio may typically be in the range of 6.5 to 7 grams of ground coffee per fluid ounce of hot pressurized water. That is, in the brewing of a one-ounce shot of espresso, 6.5 or more grams of ground coffee may be used. In the exemplary method of FIG. 2, by contrast, the ratio may be, for example, 13 grams of ground coffee to about 12 fluid ounces of hot pressurized water, or 22 grams of ground coffee to about 20 fluid ounces of hot pressurized water, or a ratio of about 1.1 to one. Other variations with ratios either higher or lower than 1.1 are possible, while still remaining less than the 6.5 to 7 grams of ground coffee per fluid ounce of hot pressurized water typical of espresso-brewing. For example, in one variation, the ratio is 6 grams per fluid ounce or less. In a preferred embodiment, 13.5 grams of coffee and 10 fluid ounces of water are used, or a ratio of 1.35.

The coffee produced by the described method may comprise a single serving of about 12 to 20 fluid ounces. It will be appreciated, of course, that other serving sizes, such as 5 ounces, 6 ounces, or 24 ounces, or other sizes, either greater than 20 or less than 12 ounces, may be produced. The coffee produced by the method may have a Crema layer. Preferably, the Crema layer is about ¼″ deep. However, it may have a different depth. Preferably, the Crema layer lasts for at least 10 minutes. However, the Crema layer may last for a shorter or longer time.

The apparatus of the present invention is divided into various compartments. These divisions around the operating pieces such as the motor, gearbox, and motherboard prevent the spread of any ground coffee residue and prevent unnecessary malfunctions.

### Example 1

Further details on the steps of the exemplary method executed by the apparatus of the present invention are provided as follows:

The amount of ground coffee transferred to the brewing chamber at step 210 must be sufficient to prepare a relatively large cup of brewed coffee, preferably between about 13 grams and about 22 grams of ground coffee. However, smaller or larger amounts of ground coffee may be used. Where a medium roast Columbian coffee bean is used and a 12 ounce serving of Crema Coffee is desired, 14.5 to 15 grams of coffee beans are used (to the desired taste of the consumer, 14.5 for a lighter taste, and 15 for a stronger taste).

In the preferred embodiment, the amount of coffee to be produced is selected by a user 12 ounces is selected as is the strength and the appropriate quantity of whole coffee beans are dropped into the grinder. The grinder, using a slicing action, grinds the beans to a setting of 17 millimeters.

The coffee grounds slide down a chute into a steel chamber and a sweep arm removes any remaining grounds from the grinder (the sweep arm is made of Teflon or other non reactive materials). Within the brewing chamber, the grounds are compressed with the piston at a pressure of approximately 40 pounds, distributed across the surface of the ground coffee being compressed. The surface area of ground coffee is approximately 2 and ⅛″ inches.

Next, hot pressurized water is forced through the openings at the bottom of the piston. Preferably, the temperature of pressurized hot water is 204 degrees Fahrenheit. The pressure of pressurized hot water is between approximately 110 pounds per square inch. Preferably, the duration of the step of forcing hot pressurized water through the grounds is more than 12 seconds.

The brewed Crema Coffee then emerged through the first microfilter in the brewing chamber. From start to finish, the enter process takes about 35 seconds.

The description contained herein is for purposes of illustration and not for purposes of limitation. Changes and modifications may be made to the embodiments of the description and still be within the scope of the invention. Furthermore, obvious changes, modifications or variations will occur to those skilled in the art. Also, all references cited above are incorporated herein by reference, in their entirety, for background and to assist the reader of this disclosure.

While the invention has been shown and described herein with reference to particular embodiments, it is to be understood that the various additions, substitutions, or modifications of form, structure, arrangement, proportions, materials, and components and otherwise, used in the practice and which are particularly adapted to specific environments and operative requirements, may be made to the described embodiments without departing from the spirit and scope of the present invention. Accordingly, it should be understood that the embodiments disclosed herein are merely illustrative of the principles of the invention. Various other modifications may be made by those skilled in the art which will embody the principles of the invention and fall within the spirit and the scope thereof. Thus, the reader should understand that the spirit and scope of the invention should be construed broadly as set forth in the appended claims.

1. A programmable apparatus for brewing a serving of Crema Coffee, comprising:
a brewing chamber holding approximately 13 to 25 grams of ground coffee and between 8 and 24 ounces of hot, pressurized water and having a first microfilter;
a piston for compressing approximately 1.25 grams of ground coffee per produced ounce of Crema Coffee at a force between 35 and 45 pounds, wherein the size of the grind is approximately 16 to 18.5 mm in diameter and the grind is established by a slicing motion at the setting of 4.5 complete rotations from the widest opening, in the brewing chamber, the piston having a plurality of openings creating a second microfilter; and
a pump for forcing hot water at a temperature of approximately 204 degrees Fahrenheit and at a pressure of approximately 90 to 120 pounds per square inch through the second microfilter and onto the ground coffee wherein the surface area of the ground coffee exposed to the hot water is approximately 2 and ⅛^{th} inches in the brewing chamber for approximately 1 second per produced ounce of Crema Coffee to 12 ounces or less, and adding 2 more seconds per four ounces if the serving size is greater than 12 ounces, thereby causing brewed coffee to emerge through the first microfilter;
wherein the type of coffee bean and type of roast determine the amount of grounds, size of grind, pressure of water and time of brewing; and
said apparatus produces Crema Coffee in quantities of at least 8 ounces and not more than 22 ounces.

2. The apparatus of claim 1 further comprising:
a chamber for storing coffee beans; and
a grinder for grinding coffee beans in a slicing action to produce ground coffee.

3. The apparatus of claim 1 wherein a grinding chamber has burrs set between ¼″ and ⅜″ apart to produce the ground coffee.

4. The apparatus of claim 1 wherein a sweep arm removes the coffee grounds from a grinding chamber.

5. The apparatus of claim 1, wherein Columbian coffee beans at medium roast will be ground to a size of approximately 17 millimeters, and 14.75 grams of coffee grinds are used and compressed by the piston at approximately 40 pounds of force, and approximately 12 ounces of water at a temperature of approximately 204 degrees is brewed with the grounds at a pressure of approximately 110 pounds per square inch to produce 12 ounces of Crema Coffee.

6. A programmable apparatus for making Crema Coffee comprising:
a brewing chamber of stainless steel, and of a generally cylindrical shape that can contain at least 22 grams of ground coffee produced by a slicing action and being approximately 16 and 18.5 millimeters in diameter, and said brewing chamber capable of containing at least 8 ounces and not more than 24 ounces of water where in 1.25 grams of ground coffee is used to produce approximately one ounce of Crema Coffee, said brewing chamber having a first microfilter;
a piston for compressing the ground coffee, the piston being arranged to enter the brewing chamber at an open end thereof, and capable of applying approximately 35 to 45 pounds of force distributed across the upper surface of the ground coffee, wherein the piston has a plurality of openings allowing water to be forced therethrough and creating a second microfilter; and
a pump for forcing at least 12 fluid ounces of hot, pressurized water at a pressure of approximately 90 to 130 pounds per square inch through the second microfilter, said second microfilter having a plurality of infusion holes approximately 2 mm in diameter, and through the ground coffee in the brewing chamber where the ratio between the amount of ground coffee used and amount of hot pressurized water is less than 6 grams per fluid ounce, the brewed coffee passing through the second microfilter and producing a coffee that contains a crema layer.

7. The apparatus of claim 6 further comprising:
a chamber for storing coffee beans; and
a grinder for grinding coffee beans in a slicing action to produce ground coffee.

8. The apparatus of claim 6 wherein a grinding chamber has burrs set between ¼″ and ⅜″ apart to produce the ground coffee.

9. The apparatus of claim 6 wherein a sweep arm removes the coffee grounds from a grinding chamber.

10. The apparatus of claim 6, wherein Columbian coffee beans at medium roast will be ground to a size of approximately 17 millimeters, and 14.75 grams of coffee grinds are compressed by the piston at approximately 40 pounds of force, and approximately 12 ounces of water at a temperature of approximately 204 degrees is brewed with the grounds at a pressure of approximately 110 pounds per square inch to produce 12 ounces of Crema Coffee.

10. A programmable apparatus for brewing a serving of Crema Coffee, comprising:
a chamber for storing whole coffee beans;
a grinder set at 4.5 complete rotations from the widest setting and with burrs at ¼ and ⅜ inches apart, grinding the coffee beans to size of approximately 16 to 18.5 millimeters;
a brewing chamber capable of receiving approximately 13 to 25 grams of ground coffee and between 8 and 24 ounces of hot, pressurized water, the brewing chamber having a first microfilter;
a piston for compressing approximately 1.25 grams of ground coffee per produced ounce of Crema Coffee at a force between 35 and 45 pounds within the brewing chamber and wherein the piston has a plurality of openings creating a second microfilter, allowing water to pass therethrough; and
a pump for forcing hot water at a temperature of approximately 204 degrees Fahrenheit and at a pressure of approximately 127 to 141 pounds per square inch through the second microfilter and onto the ground coffee wherein the surface area of the ground coffee exposed to the hot water is approximately 2 and ⅛^{th} inches in the brewing chamber for approximately 2.4 seconds per ounce for a 12 ounce serving, 2.03 seconds per ounce for a 16 ounce serving, and 1.8 seconds per ounce for a 20 ounce serving, thereby causing brewed coffee to emerge through the first microfilter; and
said apparatus produces Crema Coffee in quantities of at least 8 ounces and not more than 22 ounces.
